(19) United States
(12) Patent Application Publication
(10) Pub. No.: US 2010/0113673 A1
(43) Pub. Date: May 6, 2010

(54) POLYMER NANOCOMPOSITES AND FABRICATION METHODS THEREOF

(75) Inventors: Ming-Tsong LEU, Kaohsiung County (TW); Jyh-Horng WU, Kaohsiung City (TW); Yu-Hsin TSAI, Hsinchu City (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/392,078

(22) Filed: Feb. 24, 2009

(30) Foreign Application Priority Data
Oct. 31, 2008 (TW) 097142029

(51) Int. Cl. C08K 3/34

(52) U.S. Cl. 524/445

(57) ABSTRACT

A polymer nanocomposite and a fabrication method thereof are provided. The polymer nanocomposite includes an amorphous polyester body and a plurality of layered structural materials mixed with the amorphous polyester body, wherein the layered structural materials have one or more than one kind of aspect ratio. The fabrication method includes providing an amorphous polyester, providing a plurality of modified layered structural materials which have one or more than one kind of aspect ratio, mixing the modified layered structural materials uniformly, mixing the modified layered structural materials into the amorphous polyester, and forming the polymer nanocomposite by a melting process.

### CROSS REFERENCE TO RELATED APPLICATIONS

This Application claims priority of Taiwan Patent Application No. 97142029, filed on Oct. 31, 2008, the entirety of which is incorporated by reference herein.

### BACKGROUND OF THE INVENTION

1. Field of the Invention

The invention relates to a polymer nanocomposite and more particularly to an amorphous polyester nanocomposite.

2. Description of the Related Art

Polyethylene terephthalate (PET) is a thermoplastic polyester engineered plastic, polymerized by esterization of diacid and diol, which is widely used in the essential goods industry, electronics industry and so forth. However, the molecular structure of polyethylene terephthalate is regular, such that it stacks easily into crystal structures, thus negatively effecting transparency, impact resistance and dyeability of the polyethylene terephthalate. Therefore, the inventors of the present invention disclosed, in Taiwan Patent Application No. 95148406, an amorphous polyester. For the amorphous polyester, 1,3 and/or 1,4-cyclohexanedimethanol (1,3/1,4-CHDM) was added into a diol monomer to fabricate an amorphous copolyester with a wide amorphous range. Additionally, the inventors of the present invention also disclosed, in Taiwan Patent Application No. 97128612, a random amorphous copolyester. For the random amorphous copolyester, a more rigid or a softer diacid or diol group was added into the monomers to form an amorphous copolyester with a wide shrink temperature range.

Although the above copolyester materials can be widely used in the essential goods industry and electronics industry, gas barriering effects of the copolyester materials are not satisfactory. Thus, an amorphous polyester material is desired, which has better gas barriering, heat shrink and transparency effects.

U.S. Pat. No. 6,767,951 discloses a polyester body mixed with a hydrophilic block copolymer and an unmodified layered clay by melting to form a polyester nanocomposite. U.S. Pat. No. 6,486,253 discloses using at least more than two kinds of organic cationic salts to modify clay, and mixing the modified clay into polyester to form a polymer nanocomposite with gas barriering effect. U.S. Pat. No. 6,486,252 discloses using an expanding agent to pre-swell a modified layered clay, and mixes the clay into polyester by melting to form a polymer nanocomposite with gas barriering effect. U.S. publication No. US20060141183 discloses using a sepiolite-typed clay mixed with at least one kind of polyester precursor, wherein the polyester precursor is polymerized to form a polyester nanocomposite with gas barriering effect.

However, the above polymer nanocomposites are fabricated based on a crystal polyester body. Accordingly, while the materials have gas barriering effect, requirements for transparency, impact resistance and dyeability are not satisfactory.

### BRIEF SUMMARY OF THE INVENTION

The invention provides a polymer nanocomposite. The polymer nanocomposite comprises an amorphous polyester body and a plurality of layered structural materials mixed with the amorphous polyester body, wherein the layered structural materials have one or more than one kind of aspect ratio.

The invention further provides a method for fabricating a polymer nanocomposite. First, an amorphous polyester and a plurality of modified layered structural materials are provided, wherein the plurality of modified layered structural materials have one or more than one kind of aspect ratio. Then, the modified layered structural materials are mixed uniformly, and mixed into the amorphous polyester to form the polymer nanocomposite by a melting process.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic cross section of a polymer nanocomposite according to one embodiment of the invention.

### DETAILED DESCRIPTION OF THE INVENTION

The following description is of the best-contemplated mode of carrying out the invention. The description is provided for illustrating the general principles of the invention and is not meant to be limiting. The scope of the invention is best determined by reference to the appended claims.

The invention utilizes one or more than one kind of layered structural material mixed into an amorphous polyester body to form a polymer nanocomposite. The layered structural materials may be modified layered clay, which have one or more than one kind of aspect ratio. The modified layered clay is dispersed in the amorphous polyester at a nanometer sized scale. The amorphous polyester is polymerized by a diacid monomer and a diol monomer, wherein the diol monomer may contain 1,3 and/or 1,4-cyclohexanedimethanol (1,3/1,4-CHDM).

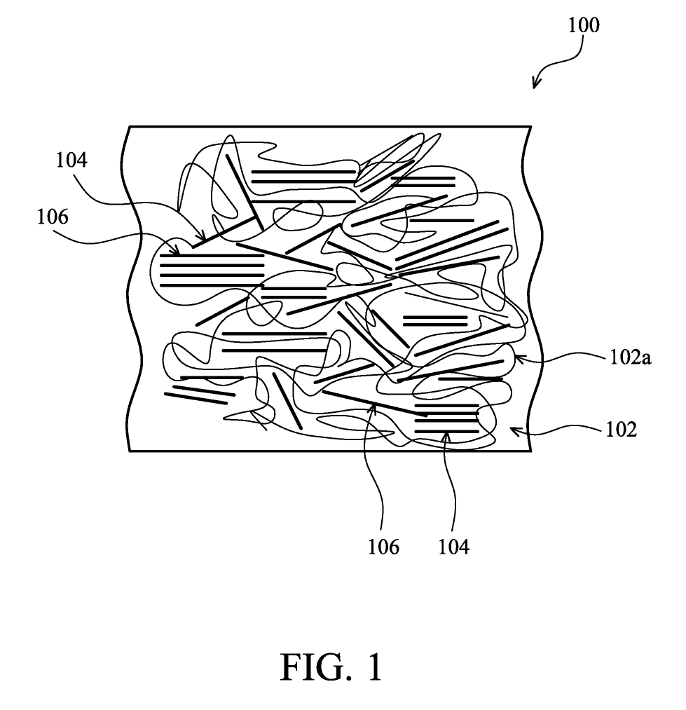

Referring to FIG. 1, a schematic cross section of a polymer nanocomposite 100 according to one embodiment of the invention is shown. A plurality of layered structural materials 104 and 106 are dispersed in an amorphous polyester body 102. The layered structural material 104 is a modified layered clay with a small aspect ratio, and the layered structural material 106 is a modified layered clay with a large aspect ratio. A polymer chain 102a of the amorphous polyester is interposed between the layered clays 104 and 106, such that the polymer nanocomposite 100 is achieved with nanometer size scale dispersion.

The invention utilizes one or more than one kind of layered clay with different aspect ratios mixed into the amorphous polyester through nanometer size scale dispersion. The structure of the layered clay has gas barriering effect. Moreover, the layered clay with more than one kind of aspect ratios can produce a random arrangement to increase the paths for gas to pass therethrough. Therefore, the gas barriering of the polymer nanocomposites are enhanced. Additionally, the polymer nanocomposites of the invention further have heat shrink and transparency effects.

In the polymer nanocomposites according to the embodiments of the invention, the layered structural materials are about 0. 1 to 20 weight %. In one embodiment of the invention, the layered structural materials may be several modified clays with two kinds of aspect ratios. One modified clay is a quaternary ammonium compound such as dimethyl distearyl ammonium chloride (DDAC) modified layered clay, referred to as a polymer grade nonoclay (PGN) (product of American Nanocor Inc.), having an aspect ratio of about 300˜500. The other is an organic modified layered clay, referred to as Cloisite 15A (C15A) (product of American Southern Clay Products Inc.), having an aspect ratio of about 75˜100, wherein an organic modified agent of C15A is dimethyl dehydrogenated tallow quaternary ammonium. In one embodiment of the invention, the two kinds of aspect ratios of the layered structural materials have a ratio of about 2 or more than 2.

The amorphous polyester is polymerized by a diacid monomer and a diol monomer, and can be represented by formula (I):

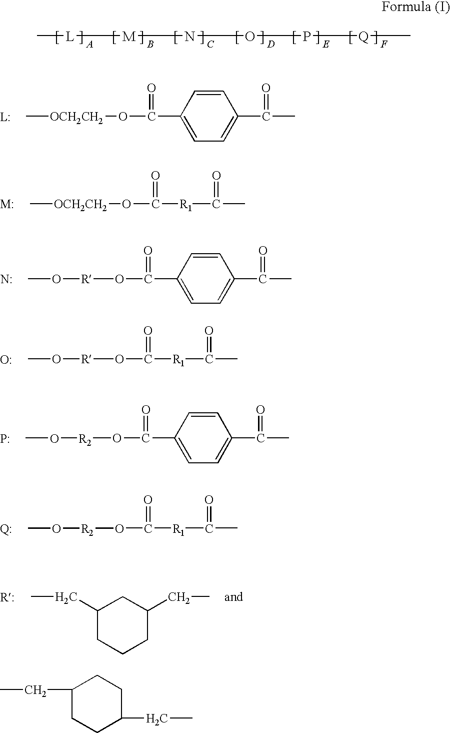

In the formula (I), R′ is 1,3-cyclohexanedimethyl and 1,4-cyclohexanedimethyl, each of R₁ and R₂, independently, is a bivalent aromatic or aliphatic group, and A, B, C, D, E and F are numbers of repeating units, wherein A is 0˜0.8, B is 0˜0.8, C is 0˜1, D is 0˜1, E is 0˜0.8, F is 0˜0.8, C+D>0.2 and A+B+E+F<0.8. The diacid monomer may be terephthalic acid (TPA) and an aromatic or an aliphatic diacid monomer. The diol monomer may be ethylene glycol (EG), 1,3 and/or 1,4-cyclohexanedimethanol and an aromatic or an aliphatic diol monomer.

In the formula (I), the aromatic diacid monomer is such as 5-tert-butylisophthalic acid (5tBIA), dimethyl-2,6-naphthalenedicaboxylate (NDC), 2,6-naphthoic acid, 2,7-naphthoic acid, 1,4-naphthoic acid, dimethyl-2,7-naphthalenedicaboxylate, dimethyl-2,3-naphthalenedicaboxylate or isoterephthalic acid (IPA). The aliphatic diacid monomer is such as succinic acid (SA), malonic acid or adipic acid. The diacid monomer based on 100 mole % can contain 0-100 mole % of the aromatic or the aliphatic diacid monomer.

In the formula (I), the aromatic diol monomer is such as 2,2-bis(4-hydroxyphenyl)propane, 1,1-bis(4-hydroxyphenyl)cyclohexane or 4,4-biphenol. The aliphatic diol monomer is such as propylene glycol, butylene glycol, polyethylene glycol (PEG) or polytetramethylene glycol (PTMO). The diol monomer based on 100 mole % can contain 0˜80 mole % of the aromatic or the aliphatic diol monomer. In the formula (I), by introducing a more rigid or a softer diacid or diol group, an amorphous polyester with a wide heat shrink temperature range of 40˜120° C. can be achieved. In one embodiment of the invention, the amorphous polyester of the formula (I) can have an intrinsic viscosity greater than 0.5 dL/g.

In one embodiment of the invention, a method for fabricating the polymer nanocomposite includes providing a modified clay with one or more than one kind of aspect ratio, uniformly mixing the modified clay by any ratio, and then mixing the modified clay into the amorphous polyester to form a mixture. Next, the mixture is melted and extruded through a twin screw extruder to form the polymer nanocomposite by a melting process. The temperature of the melting process is about 170-240° C., and the rotation rate of the twin screw extruder is about 200 to 800 rpm.

The composition, the fabrication method and related measurement results of the polymer materials for examples and comparative examples are described in detail as below.

### EXAMPLE 1

166 grams of terephthalic acid (TPA) was taken as the diacid monomer. 62 grams of ethylene glycol (EG) and 43.2 grams of 1,3-cyclohexanedimethanol and 1,4-cyclohexanedimethanol were taken as the diol monomer, wherein 1,3-cyclohexanedimethanol and 1,4-cyclohexanedimethanol were 30 mole % in the diol monomer. After two steps of esterification and polycondensation, an amorphous polyester of polyethylene terephtalate glycol (PETG) was synthesized.

A dimethyl distearyl ammonium chloride (DDAC) modified layered clay of polymer grade nonoclay (PGN) (product of American Nanocor Inc.) and an organic modified layered clay of Cloisite 15A (C15A) (product of American Southern Clay Products Inc.) were uniformly mixed by a weight ratio of 1:1 to form a clay mixture. Then, 1 part by weight of the clay mixture was mixed into 100 parts by weight of the amorphous polyester (PETG) to form a mixture. The mixture was melted and extruded at a temperature of 170˜240° C. and a rotation rate of 500 rpm by a twin screw extruder to complete the polymer nanocomposite of Example 1.

### EXAMPLES 2 AND 3

The amorphous polyester, the modified clay mixture and the fabrication method of the polymer nanocomposites of Examples 2 and 3 were the same as Example 1. The difference between Example 1 and Example 2 was that 3 parts by weight of the modified clay mixture was mixed into 100 parts by weight of the amorphous polyester (PETG) in Example 2. The difference between Example 1 and Example 3 was that 6 parts by weight of the modified clay mixture was mixed into 100 parts by weight of the amorphous polyester (PETG) in Example 3.

### EXAMPLES 4 AND 5

The amorphous polyester, and the fabrication method of the polymer nanocomposites of Examples 4 and 5 were the same as Example 1. In the polymer nanocomposites of Examples 4 and 5, only one kind of the modified clay was used. The difference between Example 1 and Example 4 was that 6 parts by weight of the modified clay Cloisite 15A (C15A) was mixed into 100 parts by weight of the amorphous polyester (PETG) in Example 4. The difference between Example 1 and Example 5 was that 6 parts by weight of the modified clay polymer grade nonoclay (PGN) was mixed into 100 parts by weight of the amorphous polyester (PETG) in Example 5.

### COMPARATIVE EXAMPLE 1

In Comparative Example 1, there was no clay added into the amorphous polyester. The amorphous polyester (PETG) of Comparative Example 1 was the same as Example 1.

Then, the polymer nanocomposites of Examples 1-5 and the polymer material of Comparative Example 1 were measured by a gas barriering test, a resistance to water test, a heat shrink test, a mechanical property test and a transparency test. An oxygen permeability (mm-c.c./m²-day), a water vapor permeability (mm-gm/m²-day), a 100° C. heat shrink percentage (%), a tensile strength (MPa), and a total light transmittance (%) were obtained through the above measurement and the measurement results are listed in Table 1.

TABLE 1
The material characteristics of Examples 1~5 and Comparative
Example 1

| | oxygen | water vapor | 100° C. heat | | |
|---|---|---|---|---|---|
| | permeability | permeability | shrink | | total light |
| | (mm-c.c./m²- | (mm-gm/m²- | percentage | tensile | transmittance |
| | day) | day) | (%) | strength (Mpa) | (%) |
| Example 1 | 7.107 | 1.187 | 43 | 42 | 82.41 |
| Example 2 | 6.908 | 1.144 | 39 | 43.5 | 80.32 |
| Example 3 | 5.663 | 1.068 | 38 | 46 | 77.59 |
| Example 4 | 7.302 | 1.106 | — | 48.5 | 73.82 |
| Example 5 | 6.583 | 0.951 | — | 46.4 | 74.83 |
| Comparative | 10.167 | 1.627 | — | 42.1 | 86.04 |
| Example 1 | | | | | |

As shown in Table 1, when comparing the polymer nanocomposite of Example 3 with the amorphous polyester (PETG) of Comparative Example 1, the oxygen permeability of the polymer nanocomposite of the invention was reduced by about 44%, the water vapor permeability was reduced by about 34%, and the tensile strength was increased by about 8.5%. Moreover, the 100° C. heat shrink percentage of the polymer nanocomposites of Examples 1˜3 achieved 38˜43% and the total light transmittance thereof achieved 77.59˜82.41%. Accordingly, the polymer nanocomposites of the invention enhanced the effects for gas barrier and mechanical strength. Meanwhile, the polymer nanocomposites of the invention also had heat shrink and transparency effects. Therefore, the polymer nanocomposites of the invention can be used for heat shrink films, packaging materials and encapsulants, such as, for example, the containers, the shrink films and the packaging materials for drinks, foods or cosmetics, the encapsulants for electronic products such as light emitting diode (LED), and the base materials for various products.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A polymer nanocomposite, comprising:
an amorphous polyester body; and
a plurality of layered structural materials mixed with the amorphous polyester body, wherein the layered structural materials have one or more than one kind of aspect ratio.

2. The polymer nanocomposite as claimed in claim 1, wherein the layered structural materials are 0.1 to 20 weight %.

3. The polymer nanocomposite as claimed in claim 1, wherein the layered structural materials comprise a modified clay having two kinds of aspect ratios, and the two kinds of aspect ratios have a ratio of 2 or more than 2.

4. The polymer nanocomposite as claimed in claim 3, wherein the modified clay having two kinds of aspect ratios comprises a quaternary ammonium compound modified layered clay having a aspect ratio of 300˜500, and an organic modified layered clay having a aspect ratio of 75-100.

5. The polymer nanocomposite as claimed in claim 1, wherein the amorphous polyester is polymerized by a diacid monomer and a diol monomer, and represented by formula (I): 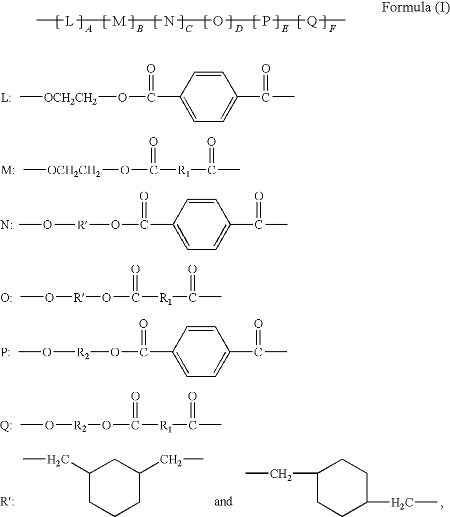
wherein R′ is 1,3-cyclohexanedimethyl and 1,4-cyclohexanedimethyl, each of R₁ and R₂, independently, is a bivalent aromatic or aliphatic group, and A, B, C, D, E and F are numbers of repeating units, wherein A is 0˜0.8, B is 0˜0.8, C is 0˜1, D is 0˜1, E is 0˜0.8, F is 0˜0.8, C+D>0.2 and A+B+E+F<0.8, the diacid monomer comprises terephthalic acid and an aromatic or an aliphatic diacid monomer, and the diol monomer comprises ethylene glycol, 1,3 and/or 1,4-cyclohexanedimethanol and an aromatic or an aliphatic diol monomer.

6. The polymer nanocomposite as claimed in claim 5, wherein the aromatic diacid monomer comprises 5-tert-butylisophthalic acid, dimethyl-2,6-naphthalenedicaboxylate, 2,6-naphthoic acid, 2,7-naphthoic acid, 1,4-naphthoic acid, dimethyl-2,7-naphthalenedicaboxylate, dimethyl-2,3-naphthalenedicaboxylate or isoterephthalic acid.

7. The polymer nanocomposite as claimed in claim 5, wherein the aliphatic diacid monomer comprises succinic acid, malonic acid or adipic acid.

8. The polymer nanocomposite as claimed in claim 5, wherein the aromatic diol monomer comprises 2,2-bis(4-hydroxyphenyl)propane, 1,1-bis(4-hydroxyphenyl)cyclohexane or 4,4-biphenol.

9. The polymer nanocomposite as claimed in claim 5, wherein the aliphatic diol monomer comprises propylene glycol, butylene glycol, polyethylene glycol or polytetramethylene glycol.

10. The polymer nanocomposite as claimed in claim 5, wherein the diacid monomer contains 0˜100 mole % of the aromatic or the aliphatic diacid monomer based on 100 mole % of the diacid monomer.

11. The polymer nanocomposite as claimed in claim 5, wherein the diol monomer contains 0˜80 mole % of the aromatic or the aliphatic diol monomer based on 100 mole % of the diol monomer.

12. The polymer nanocomposite as claimed in claim 5, wherein the amorphous polyester has an intrinsic viscosity greater than 0.5 dL/g.

13. A method for fabricating a polymer nanocomposite, comprising:
providing an amorphous polyester;
providing a plurality of modified layered structural materials, wherein the modified layered structural materials have one or more than one kind of aspect ratio;
mixing the modified layered structural materials uniformly, and into the amorphous polyester; and
forming the polymer nanocomposite by a melting process.

14. The method as claimed in claim 13, wherein the melting process is performed in a twin screw extruder with a temperature of 170 to 240° C. and a rotation rate of 200 to 800 rpm.

15. The method as claimed in claim 13, wherein the plurality of modified layered structural materials is 0.1 to 20 weight %.

16. The method as claimed in claim 13, wherein the plurality of modified layered structural materials comprise a modified clay having two kinds of aspect ratios, and the two kinds of aspect ratios have a ratio of 2 or more than 2.

17. The method as claimed in claim 16, wherein the modified clay having two kinds of aspect ratios comprises a quaternary ammonium compound modified layered clay having a aspect ratio of 300˜500, and an organic modified layered clay having a aspect ratio of 75-100.

18. The method as claimed in claim 13, wherein the amorphous polyester is polymerized by a diacid monomer and a diol monomer, and represented by formula (I): 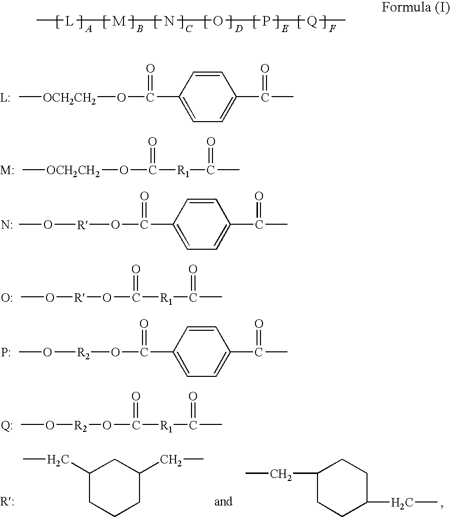
wherein R′ is 1,3-cyclohexanedimethyl and 1,4-cyclohexanedimethyl, each of R₁ and R₂, independently, is an aromatic or an aliphatic group, and A, B, C, D, E and F are numbers of repeating units, wherein A is 0˜0.8, B is 0˜0.8, C is 0˜1, D is 0˜1, E is 0˜0.8, F is 0˜0.8, C+D>0.2 and A+B+E+F<0.8.

19. The method as claimed in claim 18, wherein the diacid monomer comprises terephthalic acid, and the diol monomer comprises ethylene glycol, and 1,3 and/or 1,4-cyclohexanedimethanol, and the diol monomer contains 20˜100 mole % of 1,3 and/or 1,4-cyclohexanedimethanol based on 100 mole % of the diol monomer.

20. The method as claimed in claim 18, wherein the diacid monomer comprises terephthalic acid and 5-tert-butylisophthalic acid, the diol monomer comprises ethylene glycol, and 1,3 and/or 1,4-cyclohexanedimethanol, and wherein based on 100 mole % of the diacid monomer and 100 mole % of the diol monomer, 5-tert-butylisophthalic acid and 1,3 and/or 1,4-cyclohexanedimethanol have a total content of 20˜100 mole %.

21. The method as claimed in claim 18, wherein the diacid monomer comprises terephthalic acid and an aromatic or an aliphatic diacid monomer, and the diol monomer comprises ethylene glycol, 1,3 and/or 1,4-cyclohexanedimethanol and an aromatic or an aliphatic diol monomer.

22. The method as claimed in claim 21, wherein the aromatic diacid monomer comprises dimethyl-2,6-naphthalenedicaboxylate, 2,6-naphthoic acid, 2,7-naphthoic acid, 1,4-naphthoic acid, dimethyl-2,7-naphthalenedicaboxylate, dimethyl-2,3-naphthalenedicaboxylate or isoterephthalic acid.

23. The method as claimed in claim 21, wherein the aliphatic diacid monomer comprises succinic acid, malonic acid or adipic acid.

24. The method as claimed in claim 21, wherein the aromatic diol monomer comprises 2,2-bis(4-hydroxyphenyl)propane, 1,1-bis(4-hydroxyphenyl)cyclohexane or 4,4-biphenol.

25. The method as claimed in claim 21, wherein the aliphatic diol monomer comprises propylene glycol, butylene glycol, polyethylene glycol or polytetramethylene glycol.

26. The method as claimed in claim 21, wherein the diacid monomer contains 0˜100 mole % of the aromatic or the aliphatic diacid monomer based on 100 mole % of the diacid monomer.

27. The method as claimed in claim 21, wherein the diol monomer contains 0˜80 mole % of the aromatic or the aliphatic diol monomer based on 100 mole % of the diol monomer.

28. The method as claimed in claim 13, wherein the amorphous polyester has an intrinsic viscosity greater than 0.5 dL/g.
